(19) United States
(12) Patent Application Publication
(10) Pub. No.: US 2016/0209929 A1
(43) Pub. Date: Jul. 21, 2016

(54) METHOD AND SYSTEM FOR THREE-DIMENSIONAL MOTION-TRACKING

(71) Applicant: Jahja I. Trisnadi, Cupertino, CA (US)

(72) Inventor: Jahja I. Trisnadi, Cupertino, CA (US)

(21) Appl. No.: 15/000,993

(22) Filed: Jan. 19, 2016

Related U.S. Application Data
(60) Provisional application No. 62/105,216, filed on Jan. 20, 2015.

(51) Int. Cl. G06F 3/01; G06F 3/03; G01D 5/34

(52) U.S. Cl. CPC G06F 3/017; G01D 5/34; G06F 3/0325

(57) ABSTRACT

One embodiment provides an apparatus for tracking movements of an object in a three-dimensional (3D) space. The apparatus can include one or more lasers, one or more optical sensors, and a processing unit. The total number of lasers and optical sensors is equal to or greater than three. A respective laser is configured to emit a laser beam onto a surface of the object and a respective optical sensor is configured to detect speckles of one or more lasers scattered from the surface of the object. The processing unit is configured to compute 3D displacement of the object based on outputs of the optical sensors and generate data associated with the 3D displacement.

### RELATED APPLICATIONS

This application hereby claims priority under 35 U.S.C. §119 to U.S. Provisional Patent Application No. 62/105,216, filed on 20 Jan. 2015, entitled “THREE-DIMENSIONAL MOTION-TRACKING DEVICE,” by inventor Jahja I. Trisnadi.

### BACKGROUND

1. Field of the Invention

This disclosure is generally related to a method and system for motion-tracking. More specifically, this disclosure is related to a method and system for optical motion-tracking in a three-dimensional space.

2. Related Art

In the past decade, many new mobile devices have emerged due to the rapid development in mobile computing technologies. Nowadays tablets and smartphones are ubiquitous, and other novel devices continue to emerge. Among them, wearable computers, such as smartwatches and smartglasses, have the potential of fundamentally change people's life, more specifically, the way people interact with computers. Touchscreens have made it easier for users to interact with tablets and smartphones, but can become cumbersome for smaller size wearable computers. It is anticipated that new types of input devices are needed to further enhance many human-machine interactions.

One such device can include a hand-gesture recognition system, which not only complements touchscreens, but would be especially useful for smaller wearable computers. However, current gesture-recognition technologies are often too bulkier, consume too much power, and cost too much to be used in wearable computers.

### SUMMARY

One embodiment provides an apparatus for tracking motions of an object in a three-dimensional (3D) space. The apparatus can include one or more lasers, one or more optical sensors, and a processing unit. The total number of lasers and optical sensors is equal to or greater than three. A respective laser is configured to emit a laser beam onto a surface of the object and a respective optical sensor is configured to detect speckles of one or more lasers scattered from the surface of the object. The processing unit is configured to compute 3D displacement of the object based on outputs of the optical sensors and generate data associated with the 3D displacement.

In a variation on this embodiment, the apparatus includes a single laser and at least two optical sensors.

In a further variation, a first optical sensor, the single laser, and a second optical sensor are spatially arranged to form an “L,” with the single laser located at a corner of the “L.”

In a further variation, a first optical sensor, the single laser, and a second optical sensor are spatially arranged to form a straight line, with the single laser located between the first optical sensor and the second optical sensor.

In a further variation, the at least two optical sensors are equidistant to the single laser.

In a variation on this embodiment, the apparatus includes a single optical sensor and at least two lasers.

In a further variation, the at least two lasers turn on and off in an alternating manner.

In a further variation, a first laser, the single optical sensor, and a second laser are spatially arranged to form an “L,” with the single optical sensor located at a corner of the “L.”

In a variation on this embodiment, the optical sensor is configured to output a displacement of the detected speckles.

In a variation on this embodiment, the optical sensor includes one of: a two-dimensional (2D) complementary metal-oxide-semiconductor (CMOS) image sensor and a 2D comb array.

In a variation on this embodiment, the laser includes a vertical-cavity surface-emitting laser (VCSEL).

In a variation on this embodiment, a distance between the laser and the optical sensor is between 2 and 10 mm.

### BRIEF DESCRIPTION OF THE FIGURES

FIG. 1A illustrates an exemplary side view of 3D speckles.

FIG. 1B illustrates an exemplary cross-sectional view of the 3D speckles along cut plane A-A′.

FIG. 2 presents a diagram illustrating the geometry of an optical sensor capturing speckle patterns generated by a laser illuminated surface.

FIG. 3 presents a diagram illustrating the relationship between the speckle displacement and the displacement of the scattering surface.

FIG. 4 presents a diagram illustrating the working principle of an exemplary 3D motion-tracking system, in accordance with an embodiment of the present invention.

FIG. 5A presents a diagram illustrating an exemplary placement strategy of sensors for a 3D motion-tracking system, in accordance with an embodiment of the present invention.

FIG. 5B presents a diagram illustrating an exemplary placement strategy of sensors for a 3D motion-tracking system, in accordance with an embodiment of the present invention.

FIG. 6 presents a diagram illustrating the working principle of an exemplary 3D motion-tracking system, in accordance with an embodiment of the present invention.

FIG. 7 presents a diagram illustrating an exemplary 3D motion-tracking system having an array of lasers and sensors, in accordance with an embodiment of the present invention.

FIG. 8A shows the block diagram of an exemplary 3D motion-tracking system, according to an embodiment of the present invention.

FIG. 8B shows the block diagram of an exemplary 3D motion-tracking system, according to an embodiment of the present invention.

FIG. 9A presents a diagram illustrating an exemplary operating scenario of a 3D motion-tracking system, in accordance with an embodiment of the present invention.

FIG. 9B presents a diagram illustrating a 3D motion-tracking system functioning as a finger-navigation controller, in accordance with an embodiment of the present invention.

FIG. 10A presents a diagram illustrating an exemplary smartphone, in accordance with an embodiment of the present invention.

FIG. 10B presents a diagram illustrating an exemplary smartwatch, in accordance with an embodiment of the present invention.

FIG. 10C presents a diagram illustrating an exemplary steering wheel, in accordance with an embodiment of the present invention

In the figures, like reference numerals refer to the same figure elements.

### DETAILED DESCRIPTION

### Overview

Embodiments of the present invention provide a system and method for motion-tracking in a 3D space. An exemplary 3D motion-tracking system can include a coherent light source and at least a pair of displacement sensors. The displacement sensors can be configured to detect and output displacements of speckles scattered from a surface illuminated by the laser. By placing multiple displacement sensors at different known locations, the system can extract the relative 3D displacement of the illuminated surface. The 3D motion-tracking system is compact, thin, low-cost, and has low power consumption, which enables applications as user input module for a mobile or wearable computing device.

In this disclosure, the term “motion-detection” system can be interchangeable with the term “motion-tracking” system.

### 3D Optical Speckles

When an object is illuminated by a laser, because most surfaces are inherently rough at the scale of the laser wavelength, the backscattered light can form a random interference pattern consisting of dark and bright areas. Such a pattern is called a speckle pattern, or simply a speckle. If the illuminated object is static relative to the laser, the speckle pattern is stationary. If there is relative movement, the speckle pattern will change in a manner that represents the movement. In recent years, laser speckle patterns have been used in 2D motion-tracking applications. More specifically, by mathematically processing sequential speckle patterns, the physical displacement can be calculated

In a conventional 2D motion-tracking system, a single optical sensor that detects speckles projected onto its sensing plane can be used. The detected speckles can then be processed to provide speckle displacement information in the 2D space. Such an optical sensor along with the processing unit can be referred to as a 2D speckle displacement sensor, or simply a displacement sensor. Various technologies can be used to implement displacement sensors, including but not limited to: a 2D CMOS image sensor and a 2D comb array. A 2D CMOS image sensor can detect speckle movements by correlating sequential images, and a 2D comb array can extract displacement by counting the number of oscillations of a specific speckle spatial frequency.

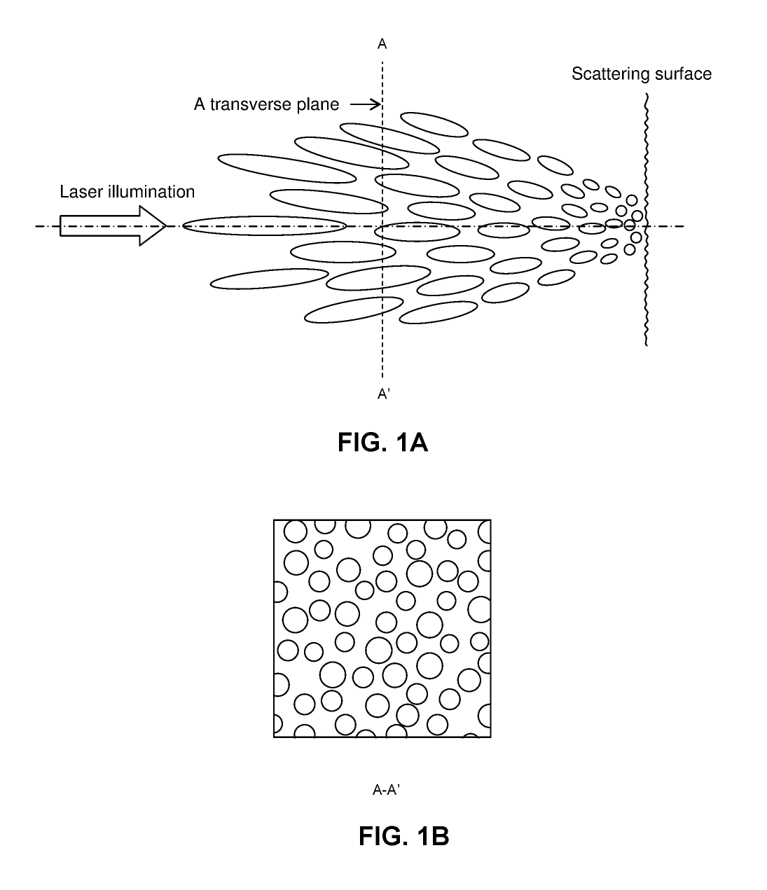

To extract 3D motion information, one may need to view the speckle itself in a 3D domain. In reality, the speckle field is not confined to a 2D surface, but fills the whole of space through which the scattered light passes. It has been shown that the speckles are three-dimensional elliptical grains that are radially pointing away from the surface illuminated area. FIG. 1A illustrates an exemplary side view of 3D speckles. FIG. 1B illustrates an exemplary cross-sectional view of the 3D speckles along cut plane A-A′.

In FIG. 1A, the collimated laser beam is shown to be illuminating the scattering surface at a normal angle, and the transverse plane at which the speckle is sampled is parallel to the surface. The speckle in FIG. 1B is often sampled by an optical sensor placed within a small observation area. From FIGS. 1A and 1B, one can imagine that when the relative position between the sensor and the scattering surface changes, the speckle pattern will shift accordingly. For example, the speckle pattern will shift according to the relative movement of the sensor in a plane that is parallel to the scattering surface. Hence, by detecting the movements of the speckles in the X-Y plane, one can derive the relative movement information of the sensor in the X-Y plane. This is the operating principle of a 2D motion-tracking device.

One can also imagine, based on FIGS. 1A and 1B, that when the relative location between the sensor and the surface changes along the Z-axis that is perpendicular to the scattering plane, the speckle pattern will shift due to the radially elongated speckles. If the relative location change is strictly along the Z-axis, the movement information (i.e., whether the sensor and the object are moving closer to or further away from each other) can be extracted by comparing sequential speckle patterns. In general cases, the relative movements between the sensor and the object include both X-Y movements and movements along the Z-axis. In such situations, a single displacement sensor cannot provide sufficient 3D displacement information.

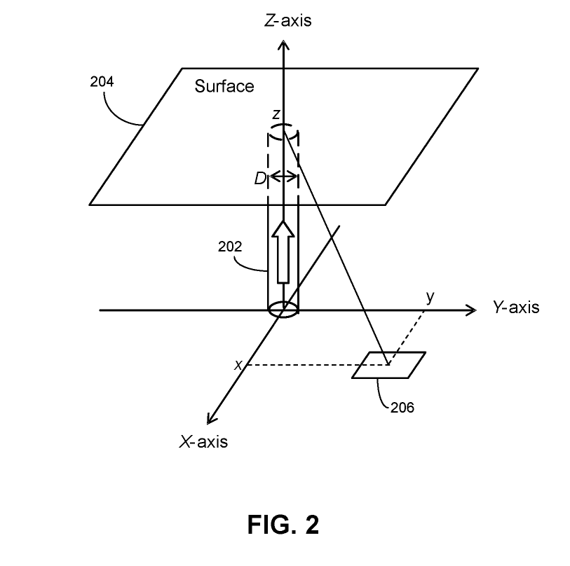

FIG. 2 presents a diagram illustrating an optical sensor capturing speckle patterns. In FIG. 2, it is assumed that laser beam 202 is propagating along the Z-axis, and scattering surface 204 is normal to the laser beam. An observation area 206 is parallel to scattering surface 204. For notation purposes, one can assume that observation area 206 lies in the X-Y plane and the origin (0, 0, 0) is taken to be the point where the laser beam axis intersect the X-Y plane. The center of observation area 206 can be noted as (x, y, 0). The X-Y plane that passes the origin can be defined by equation Z=0. Accordingly, the scattering surface lies in the plane defined by equation Z=z. FIG. 2 also shows that the diameter of laser beam 202 is D, and observation area 206 has a dimension of w×w. The size of the speckles is a function of laser wavelength (λ), the vertical distance between scattering surface 204 and observation area 206 (z), and the diameter of laser beam 202 (D). More specifically, the speckle dimension in the plane of observation area 206 is proportional to λz/D, and the speckle dimension along the Z-axis is proportional to λz²/D². Because the vertical distance between scattering surface 204 and observation area 206 is typically greater than the diameter of laser beam 202 (i.e., z>D), the 3D speckles in most situations have a larger component along the Z-axis.

When there is a displacement (which can be represented by a 3D vector) between observation area 206 and scattering surface 204, a speckle captured by observation area 206 also moves. Assuming collimated laser illumination and assuming that the 3D speckles are radially elongated grains, the displacement of the speckle is largely in the X-Y plane. More specifically, one can show that the speckle displacement in the X-Y plane is a function of the displacement between observation area 206 and scattering surface 204.

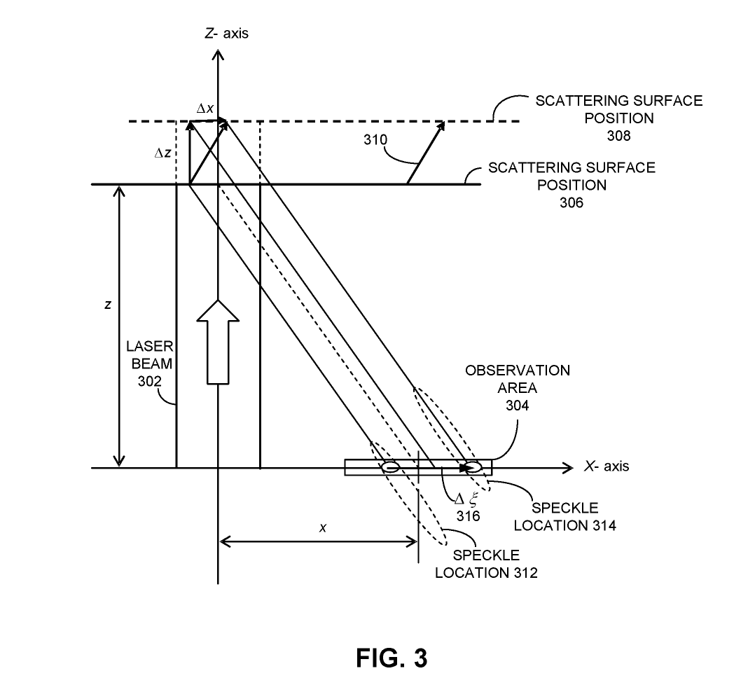

FIG. 3 presents a diagram illustrating the relationship between the speckle displacement and the displacement of the scattering surface. For simplicity of illustration, FIG. 3 shows the projections of the laser beam and speckles on the X-Z plane. In the example shown in FIG. 3, without loss of generality, laser beam 302 and observation area 304 remain stationary, and the scattering surface moves from position 306 to position 308, as indicated by a 2D vector 310. Due to the movement of the scattering surface, a speckle moves from a location 312 to a location 314. The speckle displacement along the X-axis can be denoted Δξ and is indicated by an arrow 316.

The displacement of the scattering surface can be represented by a 2D vector 310. Such a 2D vector can be decomposed into an X component Δx and a Z component Δz. Considering that the center of observation area 304 is located at (x, 0), the speckle displacement along the X-axis (Δξ) can be deduced using simple geometry. More specifically, the speckle displacement along the X-axis is the surface displacement along the X-axis plus the surface displacement along the Z-axis times a scale factor, with the scale factor being x/z, i.e.,

$$Δξ = Δ x + \frac{x}{z} Δ z .$$

Now considering the 3D situation where the surface displacement also includes a Y component, the speckle displacement will become a 2D vector (Δξ, Δη), and the component along the Y-axis (Δη) can be deduced using a similar logic, resulting in

$$Δη = Δ y + \frac{y}{z} Δ z .$$

As shown in FIGS. 2 and 3, a single displacement sensor can only provide speckle displacement information in the 2D domain (e.g., Δξ and Δη), whereas the surface displacement can involve three variables (Δx, Δy, Δz). Therefore, the speckle displacement detected by the single displacement sensor cannot provide enough information to determine the 3D displacement of the surface. In other words, the two observables detected by a single displacement sensor are not sufficient to solve for the three variables associated with the 3D displacement of the scattering surface.

In order to solve for the three unknown variables (Δx, Δy, Δz) involved in the 3D displacement, the 3D motion-tracking system needs to obtain at least three observables that are functions of the three unknown variables and are independent of each other. In some embodiments, to obtain at least three independent observables, the 3D motion-tracking system can include at least two displacement sensors that can detect the speckle displacements from at least two independent fields of view. More specifically, the two displacement sensors can provide two sets of speckle displacement data, e.g., (Δξ₁, Δη₁) and (Δξ₂, Δη₂), which can include four observables. The locations of the displacement sensors should be chosen in a way such that the four observables are independent of each other.

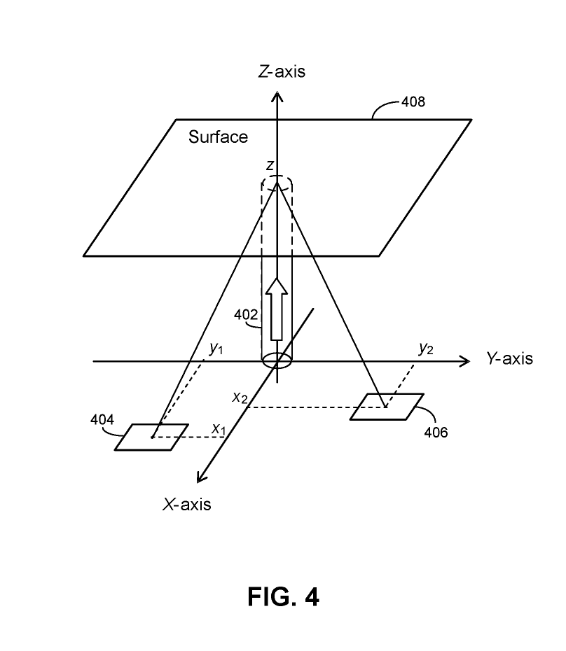

FIG. 4 presents a diagram illustrating the working principle of an exemplary 3D motion-tracking system, in accordance with an embodiment of the present invention. In FIG. 4, a 3D motion-tracking system can include a laser beam 402 and a pair of displacement sensors, sensors 404 and 406. During operation, collimated laser beam 402 is scattered by a reflective surface 408, generating speckles. Displacement sensors 404 and 406 can independently detect and output local speckle displacements. Any displacement of surface 408 can cause displacement of the local speckle patterns. The local speckle displacement at each displacement sensor is a function of the displacement of surface 408 and the location of the displacement sensor with respect to surface 408 and laser beam 402.

In the example shown in FIG. 4, a Cartesian coordinate system is used to express the locations of the displacement sensors with respect to the scattering surface and the laser beam. For example, the location of the laser (assuming the laser and the optical sensors are on the same plane) can be marked as the origin of the Cartesian coordinate system, and the sensor plane is defined as the X-Y plane. It can also be assumed that laser beam 402 propagates along the Z-axis, and reflective surface 408 is parallel to the X-Y plane. Accordingly, the locations of displacement sensors 404 and 406, expressed using the coordinates of their center points, are (x₁, y₁, 0) and (x₂, y₂, 0), respectively; and the surface 408 is within the plane of Z=z.

Using similar geometry as that shown in FIG. 3, one can express the speckle displacement at each displacement sensor as a function of the displacement of the surface (Δx, Δy, Δz), the sensor location ((x₁, y₁, 0) or (x₂, y₂, 0)), and Z. More specifically, each component (X or Y component) of the speckle displacement can be expressed independently, because the X and Y components of the speckle displacement are orthogonal to each other. For example, the X component of the speckle displacement at displacement sensor 404 can be expressed as a function of displacements along the X- and Z-axes (Δx and Δz), x₁, and z, i.e.,

$${Δξ}_{1} = Δ x + \frac{{x}_{1}}{z} Δ z .$$

The Y component of the speckle displacement at displacement sensor 404 can be expressed as a function of displacements along the Y- and Z-axes (Δy and Δz), y₁, and z, i.e.,

$$Δ {η}_{1} = Δ y + \frac{{y}_{1}}{z} Δ z .$$

The X and Y components of the speckle displacement at displacement sensor 406 can be similarly expressed, i.e.,

$${Δξ}_{2} = Δ x + \frac{{x}_{2}}{z} Δ z and {Δη}_{2} = Δ y + \frac{{y}_{2}}{z} Δ z .$$

Now we have four observables (Δξ₁, Δη₁, Δξ₂, and Δη₂) and three unknown variables (Δx, Δy, Δz), the four observables being more than enough to solve for the three unknown variables. In fact, if the sensors are independently located (e.g., x₁≠x₂, y₁≠y₂, or both), we can ignore one observable and use the remaining three observables to solve for the three unknown variables. The extra observable, on the other hand, can sometimes be used to improve the detection accuracy. Alternatively, additional information, such as the rotation of the scattering surface can be extract by incorporating the extra observable.

The equations that relate the speckle displacements to the displacement of the scattering surface can also be expressed using a matrix form. If the chosen observables include Δξ₁, Δη₁, and Δξ₂, the associated equations can be expressed as:

$$( \begin{matrix}{Δξ}_{1} \\ {Δη}_{1} \\ {Δξ}_{2}\end{matrix} ) = ( \begin{matrix}1 & 0 & {x}_{1} / z \\ 0 & 1 & {y}_{1} / z \\ 1 & 0 & {x}_{2} / z\end{matrix} ) ( \begin{matrix}Δ x \\ Δ y \\ Δ z\end{matrix} ) = A \cdot ( \begin{matrix}Δ x \\ Δ y \\ Δ z\end{matrix} ) .$$

Note that this example is for illustration purposes only. In practice, one may wish to select different observables to solve for (Δx, Δy, Δz). In this example, matrix A is non-singular if x₁≠x₂, and one can solve for the surface displacement variables by inverting matrix A. Note that if x₁=x₂, a different set of observables may be selected. The surface displacement can be calculated using:

$$( \begin{matrix}Δ x \\ Δ y \\ Δ z\end{matrix} ) = \frac{1}{{x}_{1} - {x}_{2}} ( \begin{matrix}- {x}_{2} & 0 & {x}_{1} \\ - {y}_{1} & {x}_{1} - {x}_{2} & {y}_{1} \\ z & 0 & - z\end{matrix} ) ( \begin{matrix}{Δξ}_{1} \\ {Δη}_{1} \\ {Δξ}_{2}\end{matrix} ) = {A}^{- 1} \cdot ( \begin{matrix}{Δξ}_{1} \\ {Δη}_{1} \\ {Δξ}_{1}\end{matrix} ) .$$

One can see from the above equation that, if the sensor locations with respect to the laser and the scattering surface are known, any displacement of the scattering surface can be derived from the detected speckle displacement data. Note that Δz is a function of z, which can vary with the displacement of the scattering surface. Assuming an initial value z=z₀, one can integrate the equation of Δz to determine the absolute z value, i.e., the absolute Z position of the scattering surface. However, for most applications, only the qualitative relative displacement is needed; hence, the value of z in the above equation can be represented using a constant (e.g., the average distance between the scattering surface and the sensor over the operational range of the system). Therefore, matrix A, and hence A⁻¹, can be treated as a constant matrix. The (Δx, Δy, Δz) can be calculated at different times (e.g., at every millisecond) to enable the relative movements of the scattering surface to be determined based on the time-dependent variations of (Δx, Δy, Δz).

Although in principle the two displacement sensors can be placed anywhere in the X-Y plane, carefully placed sensors can enhance resolution and increase computational efficiency. For example, by choosing an appropriate coordinate system and sensor locations, certain elements in matrix A⁻¹ can be reduced to 0, making calculation of (Δx, Δy, Δz) more efficient. In some embodiments, the sensors and the laser can be arranged into a perpendicular “L” configuration, with the laser at the corner of the “L” and the sensors at the legs of the “L.” In further embodiments, the sensors at the legs of the “L” are equidistant to the laser.

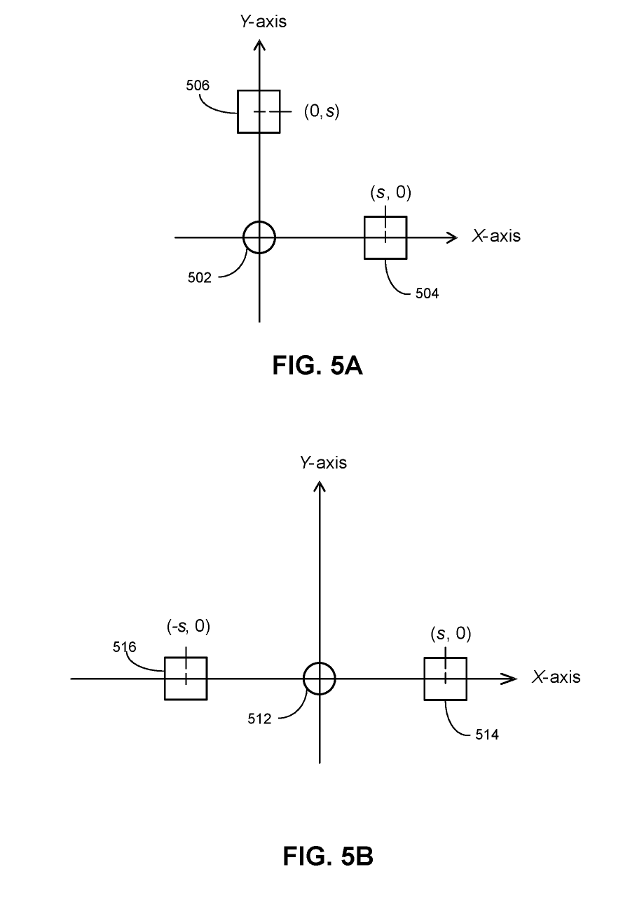

FIG. 5A presents a diagram illustrating an exemplary placement strategy of sensors for a 3D motion-tracking system, in accordance with an embodiment of the present invention. For simplicity, FIG. 5A only shows the X-Y plane, within which laser 502 and displacement sensors 504 and 506 are located. More specifically, laser 502 is located at the origin, displacement sensor 504 at (s, 0) and sensor 506 at (0, s). Accordingly, the displacement of a scattering surface can be calculated as:

$$( \begin{matrix}Δ x \\ Δ y \\ Δ z\end{matrix} ) = ( \begin{matrix}0 & 0 & 1 \\ 0 & 1 & 0 \\ z / s & 0 & - z / s\end{matrix} ) ( \begin{matrix}{Δξ}_{1} \\ {Δη}_{1} \\ {Δξ}_{1}\end{matrix} ) .$$

As one can see, the displacement calculation becomes straightforward with a reduced number of non-zero coefficients. In addition to the enhanced computational efficiency, this “L” shaped configuration can also enable a more compact device packaging. For example, if the displacement sensors are located at different quadrants of the X-Y plane, the packaged device will be significantly larger than the one with the “L” shaped configuration. On the other hand, if the sensors are located within the same quadrant, the motion-tracking system may have a lower resolution due to the closeness of the sensors. In addition to the “L” configuration, an “I” configuration where the two sensors are placed at opposite sides of the laser along a straight line can also provide similar benefits.

FIG. 5B presents a diagram illustrating an exemplary placement strategy of sensors for a 3D motion-tracking system, in accordance with an embodiment of the present invention. Similar to FIG. 5A, FIG. 5B only shows the X-Y plane, within which laser 512 and sensors 514 and 516 are located. In FIG. 5B, the sensors and the laser form an “I,” with the laser located at the center point of the “I.”

Other configurations are also possible, as long as the two sensors are sufficiently separated.

In addition to the exemplary systems shown in FIG. 4, the 3D motion-tracking system may take on different forms. For example, it can have different number of sensors or different number of lasers, as long as the total number of lasers and sensors is greater than or equal to 3.

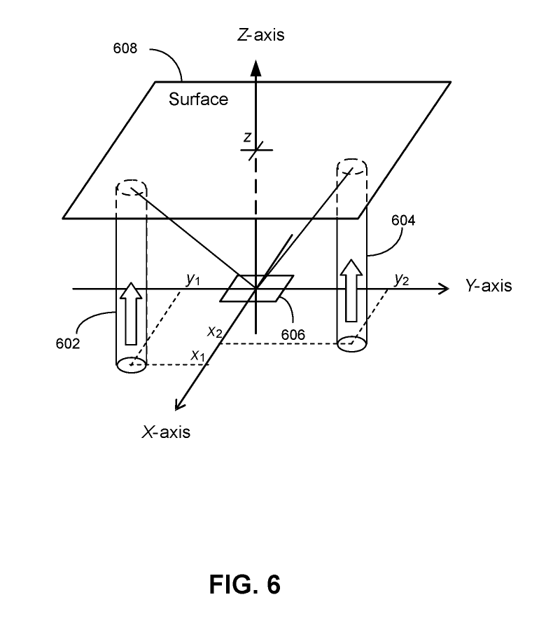

In some embodiments, a 3D motion-tracking system can have two lasers and one sensor. FIG. 6 presents a diagram illustrating an exemplary 3D motion-tracking system, in accordance with an embodiment of the present invention. In FIG. 6, a 3D motion-tracking system can include laser beams 602 and 604 and a displacement sensor 606. During operation, collimated laser beams 602 and 604 scatter from a reflective surface 608, generating speckles that can be detected by displacement sensor 606. Because laser beams 602 and 604 illuminate independent areas of the surface, their speckle patterns are independent of each other.

In some embodiments, laser beams 602 and 604 can be turned on and off in an alternating manner to allow sensor 606 to detect speckle displacement for each laser. In the example shown in FIG. 6, sensor 606 is located at the origin (0, 0, 0), laser 602 is located at (x₁, y₁, 0), and laser 604 at (x₂, y₂, 0). The 2D speckle displacement for laser 602 (i.e., the speckle displacement detected by sensor 606 when laser 602 is on and laser 604 is off) can be denoted as (Δξ₁, Δη₁), and the 2D speckle displacement for laser 604 can be denoted as (Δξ₂, Δξ₂). Note that Δξ and Δη referred to the X and Y components of the 2D speckle displacement, respectively. Here we assume that the two laser beams experience the same surface displacement.

Following similar geometry shown in FIG. 3, the displacement of the scattering surface 608 (Δx, Δy, Δz) can be calculated based on the speckle displacements observed by sensor 606, and be expressed as:

$$( \begin{matrix}Δ x \\ Δ y \\ Δ z\end{matrix} ) = \frac{1}{{x}_{1} - {x}_{2}} ( \begin{matrix}- {x}_{2} & 0 & {x}_{1} \\ - {y}_{1} & {x}_{1} - {x}_{2} & {y}_{1} \\ - z & 0 & z\end{matrix} ) ( \begin{matrix}{Δξ}_{1} \\ {Δη}_{1} \\ {Δξ}_{2}\end{matrix} ) .$$

In addition to the exemplary systems shown in FIGS. 4 and 6, the 3D motion-tracking system may take on different forms. For example, it can have different number of sensors or different number of lasers, as long as the total number of lasers and sensors is greater than or equal to 3.

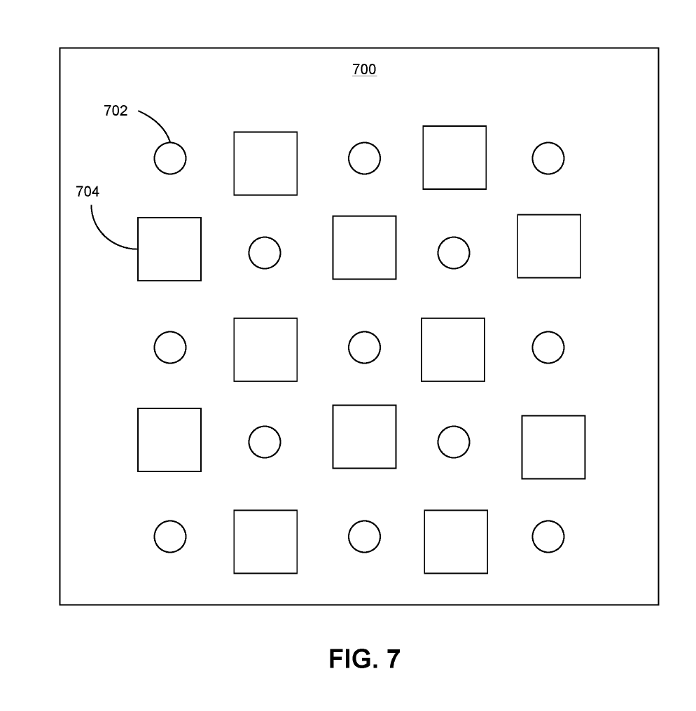

A system with more lasers and more sensors can have a larger operational range. In some embodiments, a number of lasers and sensors can be arranged into an array to form a large-area 3D motion-tracking system. FIG. 7 presents a diagram illustrating an exemplary 3D motion-tracking system having an array of lasers and sensors, in accordance with an embodiment of the present invention.

In FIG. 7, a 3D motion-tracking system 700 includes an array of lasers (e.g., laser 702) and sensors (e.g., sensor 704). The lasers can be configured to have a coordinated on/off cycle to allow one or more lasers to share a sensor. 3D movements of a surface that scatters any one or more of the laser beams can be detected.

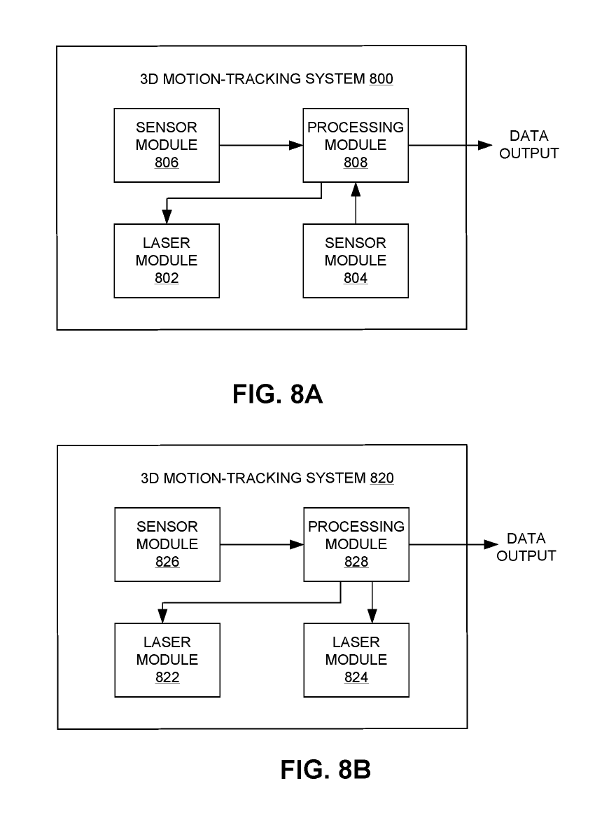

FIG. 8A shows the block diagram of an exemplary 3D motion-tracking system, according to an embodiment of the present invention. In FIG. 8A, 3D motion-tracking system 800 includes a laser module 802, sensor modules 804 and 806, and a processing module 808.

Laser module 802 can include a laser diode (LD) and a laser driver. A typical LD can include a vertical-cavity surface-emitting laser (VCSEL), which has a compact form factor and costs less than edge-emitting lasers. The wavelength of the LD can be selected to be at the near-infrared (near-IR) range, e.g., 850 nm. Other wavelengths are also possible. The laser module may also include a lens to collimate the output of the LD. In one embodiment, the collimated beam can have a 1/e² width (diameter) of 0.6 mm. The LD, LD driver, and the lens should comply with the Class I eye safety requirement of IEC 60825-1. For example, the maximum output power of the LD should be less than 0.743 milliwatt at 850 nm wavelength.

Sensor modules 804 and 806 can include standard off-the-shelf displacement sensors that can output data indicating the 2D speckle displacement. Examples of the off-the-shelf sensors can include, but are not limited to: a correlation-based CMOS image sensor and a 2D comb array. The term “2D comb array” can be referred to a planar array of a number of regularly spaced and electrically connected photosensitive elements extending substantially in at least two non-parallel directions, and having periodicity in two dimensions. Each sensor module may include a light-sensing component and a processing unit. The light-sensing component can be an optical sensor. Images captured by the light-sensing component are digitized and processed by the processing unit to provide speckle displacement data. The surface area of the light-sensing component can be between 0.05 mm² and 1 mm². In some embodiments, the light-sensing component includes a 2D comb array with a dimension of 0.4 mm×0.4 mm. Larger sensors can provide higher resolution but consume more power and require larger packaging. The distance between the optical sensors and the laser is carefully chosen to ensure sufficient motion-tracking resolution over a wide range. In some embodiments, this distance can be between 1 mm and 20 mm, preferably between 2 mm and 10 mm, more preferably around 5 mm. The distance to the laser from the two optical sensors can be the same or different. In one embodiment, both optical sensors are 5 mm away from the laser, and the optical sensors and the laser form a perpendicular “L” with the laser at the corner of the Processing module 808 receives 2D speckle displacement data from sensor modules 804 and 806 and computes the 3D motion data based on the received data and a number of known parameters that can include the average distance to the scattering surface and the distance between the sensor and the laser. Processing module 808 can also output data associated with the displacement to components outside of 3D motion-tracking system 800. For example, if 3D motion-tracking system 300 is used an a user input device for a wearable computer, processing module 808 can output the data to other control units of the wearable computer, which can then control, for example, the display of the wearable computer according to the data. In some embodiments, processing module 808 can output displacement data, which can be used to calculate motion. In some embodiments, processing module 808 can directly output motion data.

Alternatively, sensor modules 804 and 806 can be optical sensors that do not have computation capabilities. In other words, they are not the off-the-shelf packaged components that can output the 2D speckle displacement data. They do not include a processing unit in their package, and hence are much smaller than the off-the-shelf sensor modules. Signals from optical sensors 804 and 806 can be sent to processing module 808 for processing. In such a scenario, processing module 808 computes both the 2D speckle displacement data at each optical sensor and the 3D motion data.

Other standard circuit components that are useful for the operation of 3D motion-tracking system 800, such as analog-to-digital converters (ADCs), power modules, input/output modules, and microcontrollers are not shown in FIG. 8A. 3D motion-tracking system 800 can be compact in size and has low power consumption to enable applications in portable mobile or wearable devices (e.g., smartphones and smartwatches). In some embodiments, the various components, including the sensors, the laser, and the processing unit, in 3D motion-tracking system 800 can be enclosed into a single module, using system-in-a-package (SiP) technology. The package of the single module can include a surface that is transparent to the wavelength of the laser to allow scattered light to reach the sensors. A mini collimating lens can be part of the package, at a location corresponding to the laser. In some embodiments, the various components (with the exception of the laser) in 3D motion-tracking system 800 can be integrated onto a single chip, such as a Si chip. For example, a single Si chip can integrate the optical sensors, the processing units, and other components (e.g., ADCs). The single Si chip and a VCSEL can then be placed inside a package, which can include a surface that is transparent to the wavelength of the laser and a collimating lens on such a surface. Integration can significantly reduce the size of 3D motion-tracking system 800. In some embodiments, 3D motion-tracking system 800 can have a dimension of 8 mm (length)×8 mm (width)×1 mm (thickness).

The operational range of the 3D motion-tracking system can be determined based on the distance between the laser and the optical sensor. The operational vertical motion-tracking range can be proportional to the distance between the laser and the optical sensor. In some embodiments, the vertical operational range can be up to 10 times the laser-to-sensor distance. If the laser-to-sensor distance is about 5 mm, the vertical operational range can be roughly up to 50 mm. On the other hand, the lateral operational range is only limited by the size of the scattering surface. For a finger navigation system that relies on a finger to interact with the laser beam, the lateral operational range can be around a few centimeters (e.g., 2 cm across).

FIG. 8B shows the block diagram of an exemplary 3D motion-tracking system, according to an embodiment of the present invention. In FIG. 8B, 3D motion-tracking system 820 can includes laser modules 822 and 824, a sensor module 826, and a processing module 828. Laser modules 822 and 824 can be similar to laser module 802 shown in FIG. 8A. Sensor modules 826 can be similar to sensor module 802 or 804 shown in FIG. 8A. In addition to compute the 3D motion data and/or 2D speckle displacement data, processing module 828 can also be configured to control the on and off of laser module 822.

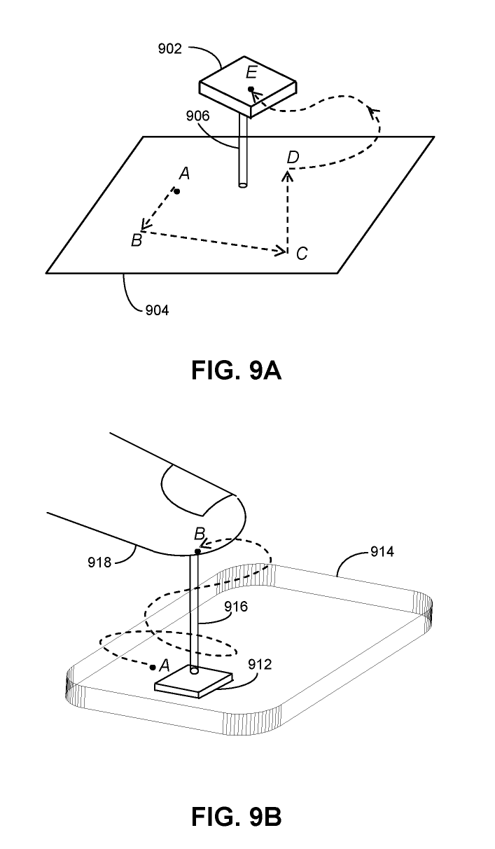

The compact, low-power-consumption 3D motion-tracking system can have many applications, notably in the area of optical navigation. For example, it can be used in a computer mouse that can translate motions in a 3D space into commands. FIG. 9A presents a diagram illustrating operating scenario of a 3D motion-tracking system, in accordance with an embodiment of the present invention.

In the example shown in FIG. 9A, a 3D motion-tracking system 902 moves relative to a stationary surface 904 while laser beam 906 emitted from 3D optical mouse 902 scatters from surface 904. 3D motion-tracking system 902 can move in a 3D space, tracking a path A-B-C-D-E. More specifically, points A, B, and C are on surface 904, while points D and E are above surface 904. Because 3D motion-tracking system 902 has the ability to track motion in the 3D space, it can track not only the lateral movements (e.g., movements along path A-B-C on surface 904) but also the vertical movement from point C to point D and a free 3D movement along path D-E. In some embodiments, the 3D motion-tracking system can function as a 3D computer mouse.

Compared to the conventional 2D computer mouse that can only detect lateral movements, the additional degree of freedom enables the 3D computer mouse to have more functions than the 2D mouse. For example, in addition to using movements of the mouse to control the position of a pointer on the screen (which is also in a 2D space), a conventional 2D mouse can also include one or more buttons. A user can input commands through the mouse to a computer by clicking the button(s) on the computer. For a typical 2-botton mouse, a single click on the left button can select an object on the screen, whereas a double click can open or execute the object. Because a 3D mouse can detect vertical movements, it can allow the user to use vertical movements to input commands. For example, instead of clicking a button, a user can move the mouse downwardly to select an object; and instead of double clicking the button, a user can move the mouse up-and-down twice to open or execute the object. It is also possible to program the system to allow a user to input other types of user commands using the vertical movements or combinations of lateral and vertical movements of the 3D mouse. This additional ability to detect vertical movements effectively can provide the 3D mouse with additional functions over the conventional 2D mouse.

The 3D motion-tracking system can also function as a navigation controller that allows a user to use his fingertip to input commands to (or, to navigate a graphic user interface of) a computing device. The user can operate the navigation controller using a method that is similar to operating a pointing device. FIG. 9B presents a diagram illustrating the 3D motion-tracking system functioning as a finger-navigation controller, in accordance with an embodiment of the present invention.

In FIG. 9B, 3D motion-tracking system 912 is located on the top surface of a portable computing device 914 and emits a laser beam 916. A fingertip 918 can intercept laser beam 916, causing laser beam 916 to scatter from the surface of fingertip. The scattered light can be collected by optical sensors of 3D motion-tracking system 912. In the example shown in FIG. 9B, fingertip 918 moves relative to 3D motion-tracking system 912 (which remains stationary along with portable computing device 914), tracking a 3D path A-B. While fingertip 918 moves relative to 3D motion-tracking system 912, and hence laser beam 916, the speckle patterns detected by optical sensors of 3D motion-tracking system 912 shift accordingly. Based on the shifted speckle patterns, 3D motion-tracking system 912 can track movements of fingertip 918, both in the lateral domain (parallel to the surface of portable device 914) and in the vertical domain (perpendicular to the surface of portable device 914).

In some embodiments, portable computing device 914 can be configured to allow a user to interact with portable computing device 914 by moving his fingertip (possibly the tip of his thumb) over 3D motion-tracking system 912. This is different from the gesture performed by the user on the touchscreen of the portable device 914. More specifically, to perform a gesture on the touchscreen, a user has to physically move his fingertip to a location on the screen that corresponds to the intended target. For example, to select an icon, a user needs to put his fingertip on top of the icon on the touchscreen. As the size of the touchscreen increases (e.g., large screen smartphones and tablet computers), a user may need both hands to operate the portable device. On the other hand, in embodiments of the present invention, a user can input commands by moving his fingertip within a relatively small area (e.g., a square of a few centimeters above 3D motion-tracking system 912, making it possible to operate portable device 914 using one hand, even if the screen of portable device 914 may be larger than the user's hand. In situations where portable computing device 914 does not have a touchscreen, 3D motion-tracking system 912 can allow the user to use hand gestures to enter commands, which is more efficient and flexible than pushing arrow buttons.

Many smartphone or tablet computers have a home button that allows a user to go back to the home screen or wake up a sleeping device. Once the home screen is displayed, a user can use finger gestures on the touchscreen to select and open apps. As discussed previously, as the screen size of the smartphones gets bigger, it can become difficult for a user to operate a smartphone using one hand. For example, when operating the smartphone, a user typically holds the phone with one hand, and uses the thumb of the same hand to press down the home button to wake up the phone. Subsequently, the user may intend to use the same thumb to select icons on the screen. The home button is typically located at the bottom of the phone. For smartphones with larger screens, it can be difficult for a user to operate the home button and select icons located at the top of the screen. To solve this problem, in some embodiments, the home button of a smartphone or a tablet computer can incorporate a 3D motion-tracking system to allow a user to operate the home button and select any icon on the screen using the same hand that holds the phone or tablet.

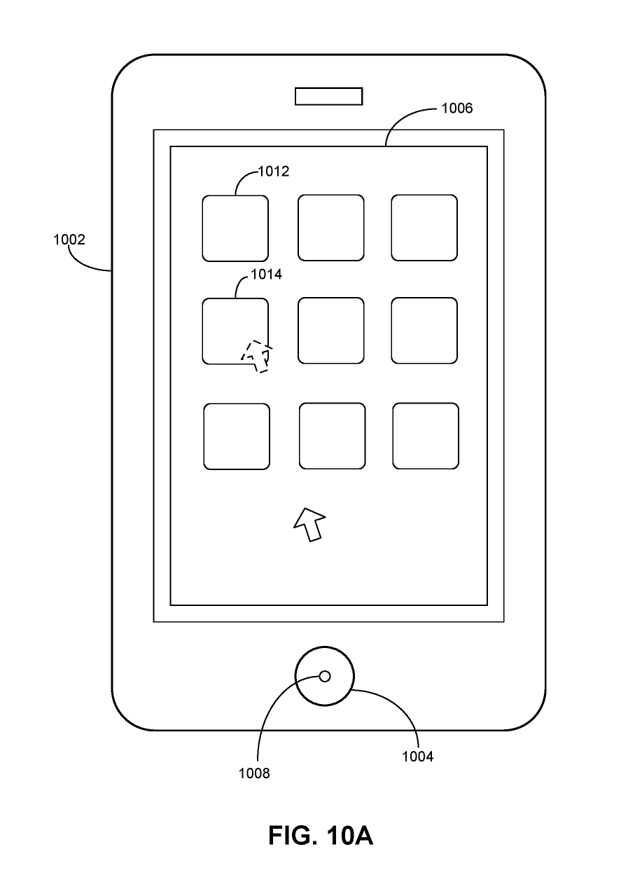

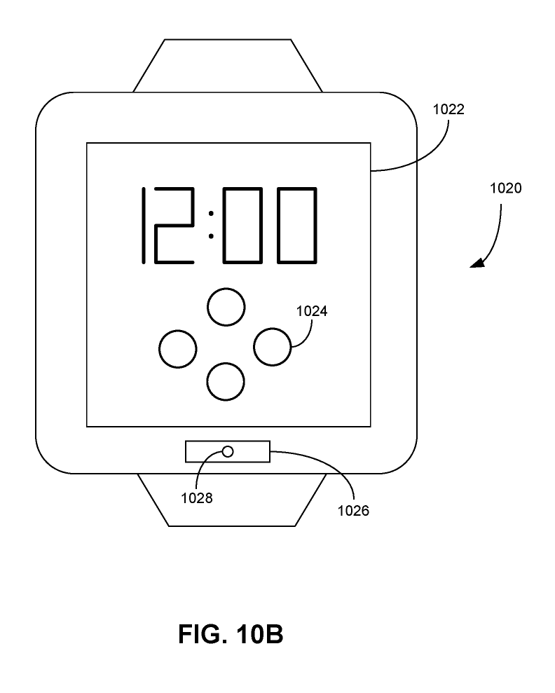

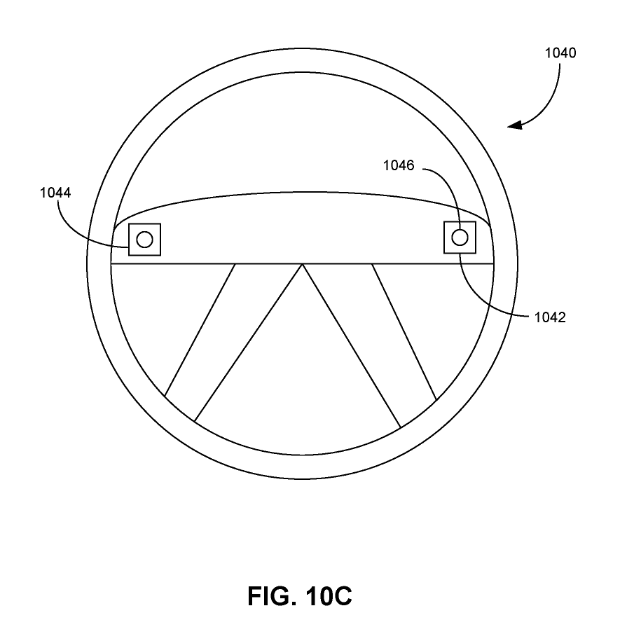

FIG. 10A presents a diagram illustrating an exemplary smartphone, in accordance with an embodiment of the present invention. In FIG. 10A, smartphone 1002 includes home button 1004 and a display 1006. Display 1006 can either be a touchscreen display or a regular display, and can display a number of selectable icons, such as icons 1012 and 1014. Home button 1004 can include a 3D motion-tracking system 1008. In some embodiments, instead of being a physical button that can be mechanically pushed by a user to input a command, home button 1004 can be a virtual button that can interface with the user in a non-contact fashion. In alternative embodiments, home button 1004 can include an additional mechanically operated switch to allow the user to turn on and off 3D motion-tracking system 1008 by mechanically pushing home button 1004. To enable operations of 3D motion-tracking system 1008, home button 1004 can also include an opening, through which a laser beam is emitted, and the laser speckles scattered from a surface are collected.

In some embodiments, a user can operate home button 1004 by placing a fingertip on top of or near 3D motion-tracking system 1008. For example, the user can hover his fingertip above 3D motion-tracking system 1008, and the laser beam emitted by 3D motion-tracking system 1008 can be scattered by the skin of his finger. Optical sensors that are placed apart within 3D motion-tracking system 1008 capture speckles of the scattered light. The movements of the user's fingertip with respect to the laser beam can cause the speckles to move accordingly. 3D motion-tracking system 1008 can then detect the movements of the user's fingertip in the 3D space based on detected movements of the speckles. The detected movements of the user's fingertip can then be converted into a user command. This way, compared with a conventional home button that only allows the user to input commands using a small number of finger actions (e.g., single click, double click, extended holding, etc.), this novel home button can provide users with a great number of ways to input user commands. For example, portable system 1002 can be configured to allow the user to use lateral movements of his fingertip to move a pointer on display 1006 and to use vertical movements to make icon selections. In the example shown in FIG. 10A, to select icon 1014, a user can first move his fingertip laterally toward icon 1014, causing the pointer on the screen to move toward icon 1014. Once the pointer is over icon 1014, the user can move his finger vertically (e.g., push or lift) to select the icon. This way a user can select any icon shown on display 1006 by simple, localized movements of his fingertip, without physically touching the displayed icon or clicking on certain arrow buttons.

In addition to using lateral movements to move a pointer and using vertical movements to selects, smartphone 1002 can also be configured to recognize other types of user commands (e.g., the ones that use a combination of the lateral and vertical movements), thus allowing a single home button to provide many more functions. For example, lifting up the finger can turn up the audio volume, and pressing down the finger can turn down the audio volume.

FIG. 10B presents a diagram illustrating an exemplary smartwatch, in accordance with an embodiment of the present invention. In FIG. 10B, smartwatch 1020 includes a display 1022 and a home button 1026. Display 1022 can either be a touchscreen display or a regular display, and can display, in addition to time, a number of selectable icons, such as icon 1024. Home button 1026 can include a 3D motion-tracking system 1028. 3D motion-tracking system 1028 can function similarly as 3D motion-tracking system 1008 shown in FIG. 10A. More specifically, it can allow a user to use finger movements in the 3D space to input command to smartwatch 1020.

In addition to the portable device, the 3D motion-tracking system can also be used in settings of the Internet of Things (IoT). For example, a kitchen appliance can implement such a system to allow a user to control the appliance without touching the appliance. For example, a user can wave his hand or move his finger tip in front of the control panel of an oven to set the temperature and/or cooking time of the oven without touching the control panel. This non-touch control can be convenient to the user, because during cooking, the user may have a greasy hand.

Another example can include providing user controls in an automobile. FIG. 10C presents a diagram illustrating an exemplary steering wheel in a car, in accordance with an embodiment of the present invention. In FIG. 10C, a steering wheel 1040 includes two user-input buttons, buttons 1042 and 1044. Each input button can include a 3D motion-tracking system. For example, user-input button 1042 can include a 3D motion-tracking system 1046. While driving a car, a driver, with his hand on steering wheel 1040, can push a user-input button to turn on the 3D motion-tracking system, and can then moves his fingertip over the 3D motion-tracking system in a 3D domain to input various user commands. For example, lateral movements may result in cursors displayed on the car display to move, and vertical movements may result in a selectable item being selected. For example, a user may laterally move his fingertip to flip through a music catalog, and then press down his fingertip to select a music piece to be played in the sound system. By implementing one or more 3D motion-tracking systems on the steering wheel, a smart car can allow the user to control the various auxiliary devices on the car without taking his hand off the steering wheel. For example, a user can adjust the radio volume, change the station, make a phone call, etc., simply by moving his fingertip above the 3D motion-tracking system.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. An apparatus for tracking motions of an object in a three-dimensional (3D) space, comprising:
one or more lasers, wherein a respective laser is configured to emit a laser beam onto a surface of the object;
one or more optical sensors, wherein a respective optical sensor is configured to detect speckles of one or more lasers scattered from the surface of the object, and wherein a total number of lasers and optical sensors is equal to or greater than three; and
a processing unit configured to compute 3D displacement of the object based on outputs of the optical sensors and generate data associated with the 3D displacement.

2. The apparatus of claim 1, comprising a single laser and at least two optical sensors.

3. The apparatus of claim 2, wherein a first optical sensor, the single laser, and a second optical sensor are spatially arranged to form an “L,” with the single laser located at a corner of the “L.”

4. The apparatus of claim 2, wherein a first optical sensor, the single laser, and a second optical sensor are spatially arranged to form a straight line, with the single laser located between the first optical sensor and the second optical sensor.

5. The apparatus of claim 2, wherein the at least two optical sensors are equidistant to the single laser.

6. The apparatus of claim 1, comprising a single optical sensor and at least two lasers.

7. The apparatus of claim 6, wherein the at least two lasers turn on and off in an alternating manner.

8. The apparatus of claim 6, wherein a first laser, the single optical sensor, and a second laser are spatially arranged to form an “L,” with the single optical sensor located at a corner of the “L.”

9. The apparatus of claim 1, wherein the optical sensor is configured to output a displacement of the detected speckles.

10. The apparatus of claim 1, wherein the optical sensor includes one of:
a two-dimensional (2D) complementary metal-oxide-semiconductor (CMOS) image sensor; and
a 2D comb array.

11. The apparatus of claim 1, wherein the laser includes a vertical-cavity surface-emitting laser (VCSEL).

12. The apparatus of claim 1, wherein a distance between the laser and the optical sensor is between 2 and 10 mm.

13. A user input device, comprising:
a three-dimensional (3D) motion-tracking module configured to track 3D movements of a user's fingertip to allow the user to input control signals to a computing device, wherein the 3D motion-tracking module comprises:
one or more lasers;
one or more optical sensors, wherein a respective optical sensor is configured to detect speckles of one or more lasers scattered from the user's fingertip, and wherein a total number of lasers and optical sensors is equal to or greater than three; and
a processing unit configured to compute 3D displacement of the fingertip based on outputs of the optical sensors and generate data associated with the 3D displacement.

14. The user input device of claim 13, wherein the 3D motion-tracking module comprises a single laser and at least two optical sensors.

15. The user input device of claim 14, wherein a first optical sensor, the single laser, and a second optical sensor are spatially arranged to form an “L,” with the single laser located at a corner of the “L.”

16. The user input device of claim 13, wherein the computing device is a smartphone, and wherein the user input device functions as a home button on the smartphone.

17. The user input device of claim 16, wherein the 3D motion-tracking device is configured to determine movements of the user's fingertip along an axis vertical to a surface of the smartphone, thereby allowing the user to input control signals to the smartphone without the user's fingertip touching the smartphone's display or pushing a physical button.

18. The user input device of claim 16, wherein the 3D motion-tracking module comprises a single optical sensor and at least two lasers.

19. The user input device of claim 15, wherein the optical sensor includes one of:
a two-dimensional (2D) complementary metal-oxide-semiconductor (CMOS) image sensor; and
a 2D comb array.

20. The user input device of claim 15, wherein a distance between the laser and the optical sensor is between 2 and 10 mm.
